(19) United States
(12) Patent Application Publication
(10) Pub. No.: US 2012/0023795 A1
(43) Pub. Date: Feb. 2, 2012

(54) Profile Configuration For Retractable Banner Display Device

(76) Inventor: BIN XIONG QIAN, Riverwood (AU)

(21) Appl. No.: 13/169,022

(22) Filed: Jun. 27, 2011

(30) Foreign Application Priority Data
Jul. 29, 2010 (AU) 334041

(51) Int. Cl. G09F 17/00

(52) U.S. Cl. 40/604

(57) ABSTRACT

The invention relates to a series of profile configurations for retractable banner display devices. A top arcuate profile and a bottom flat profile form an elongated housing having an opening which enable a banner to be extended and displayed at forefront of the almost entire physical structure of said display device without the need of other stabilising requirements. At least one connection body profile integrates with top arcuate profile(s) and bottom flat profile(s) forming structures of said display device for a single or a double-sided banner display. The profile configuration enable easy assembly and maintenance for the said display device by means of a connecting method between a bottom flat profile and a connecting body profile, that said bottom flat profile can be easily removed and replaced while the structure of the said display device sustains.

The main purpose of the Australian Design Registration is for protecting the appearance. Where present application claims innovative functions due to at least one improvement has been made, such as a connecting method between a bottom profile and a connecting body profile thereafter. exposure of advertising with increased stability and featuring easy assembly and maintenance functionalities that all integrated within a unified display devices.

2. Description of the Prior Art

There are varieties of retractable banner display devices that exist in the market. They are widely used for advertising and visual communication in venues such as exhibitions, conferences, presentations and point of sale. While many of existing arts have their advantages, there are still areas where customers' needs are not being satisfied.

Some existing arts are constructed with an opening at the top of the device; therefore the base of the device is visible from a target audience point of view when banner is erected. This represents a challenge when a full-face visual display is required.

Further more; some existing arts require stabilising feet to be incorporated in the structure of the device to ensure the stability when banner is erected. Such stabilising feet could result as a tripping hazard in certain occasions, such as at shopping mall or near public access with heavy traffic flow.

In the event of requiring access to any internal component(s) of a retractable banner display device for repair or maintenance, some existing arts require to open the side plate.

Such display devices are disclosed in U.S. Pat. No. 2002/0050083 to Zarelius; U.S. Pat. No. 7,716,860 to Burris; U.S. Pat. No. 7,040,372 to Johansson; U.S. D598,501 to Merner

### BRIEF SUMMARY OF THE INVENTION

There are numbers of objectives of the present invention

It is an objective to provide retractable banner display devices enabling banners to be extended and displayed at forefront of the structure of said display device, so it maximises the exposure of advertising. Banner(s) obscures the structure of said display devices. Therefore target audiences only view the banner(s) from front.

It is another objective to maintain the steadiness of the display devices while banner(s) is erected without the need of other stabilising feet.

It is also an objective to provide features with functionality of easy assembly and maintenance for the said display devices

### BRIEF DESCRIPTION OF THE SEVERAL VIEWS OF THE DRAWING

FIG. 1 is a section view of the profile configuration for a single-side retractable banner display device with magnified views of connection methods of profiles and an illustration of a drum structure indicating the banner extend through the opening.

FIG. 2 is a side view of a side plate for a single-side retractable banner display device; showing positions of fastening screws.

FIG. 3 is a section view of the profile configuration for a double-sided retractable banner display device with magnified views of connection methods of profiles and illustrations of drum structures with indication of banners extending through the openings.

FIG. 4 is a side view of the side plate for a double-sided retractable banner display device; showing positions of fasten screws.

FIG. 5 is a perspective view of the profile configuration for a single-side retractable banner display device.

FIG. 6 is a perspective view of the profile configuration for a single-side retractable banner display device; showing an example of a drum structure with indication of a banner extending through the opening.

FIG. 7 is a perspective view of the profile configuration completed with two opposed side plates for a single-side retractable banner display device.

FIG. 8 is a perspective view of the profile configuration for a double-sided retractable banner display device; showing an example of a drum structure with indication of banners extending through the openings.

FIG. 9 is a perspective view of the profile configuration completed with two opposed side plates for a double-sided retractable banner display device.

FIG. 10 is a top view of the profile configuration for a single-side retractable banner display

FIG. 11 is a front view of the profile configuration for a single-side retractable banner display

FIG. 12 is a rear view of the profile configuration for a single-side retractable banner display

FIG. 13 is a bottom view of the profile configuration for a single-side retractable banner display

FIG. 14 is a perspective view of an erected single-side retractable banner display

FIG. 15 is a top view of the profile configuration for a double-sided retractable banner display

FIG. 16 is a front and rear view of the profile configuration for a double-sided retractable banner display

FIG. 17 is a bottom view of the profile configuration for a double-sided retractable banner display

FIG. 18 is a perspective view of an erected double-sided retractable banner display

### DETAILED DESCRIPTION OF THE INVENTION

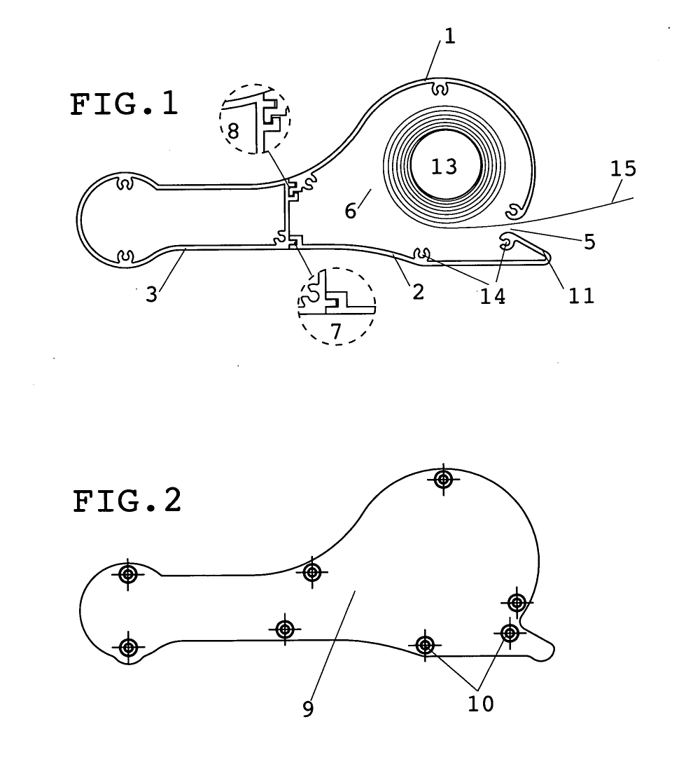

The present invention is a series of profile configurations for retractable banner display devices. FIG. 1 shows a top arcuate profile 1, a bottom flat profile 2 and a connection body profile 3 configuration for a single side said display device.

As shown in FIG. 1, a top arcuate profile 1 and a bottom flat profile 2 form an elongated housing 6 having the opening 5 located substantially low towards a ground surface. Banner 15 can be extended and retracted through said opening 5. As a result, this achieves an objective of providing retractable banner display devices enabling banners to be extended and displayed at forefront of the structure of said display device, so it maximises the exposure of advertising.

As shown in FIG. 1, a connecting body profile 3 connects to a top arcuate profile 1 with an interlocking method 8; said connecting body profile 3 connects to a bottom flat profile 2 with a non-interlocking method 7.

FIG. 2 shows a side plate 9 for a single side display device; screw positions for fastening the profile configuration for a single side retractable display device as shown in FIG. 1.

As shown in FIG. 2, two screw positions 10 match to two screw threads 14 on a bottom flat profile 2 as shown in FIG. 1. As a result of the non-interlocking connecting method 7 as shown in FIG. 1, once all screws fasten two side plates 9 to both ends of the profile configuration for a single side retractable display device as shown in FIG. 1, the bottom flat profile 2 can be removed and replaced by unscrewing two screws in screw positions 10; and the structure of the display device sustains. This achieves an objective of providing features with functionality of easy assembly and maintenance for said display device.

As shown in FIG. 1, a bottom flat profile 2 with a tapered front edge 11 extends forward over opening 5. Therefore, this substantially contributes in achieving an objective of maintaining the steadiness of said display devices while banner(s) is erected without the need of stabilising feet.

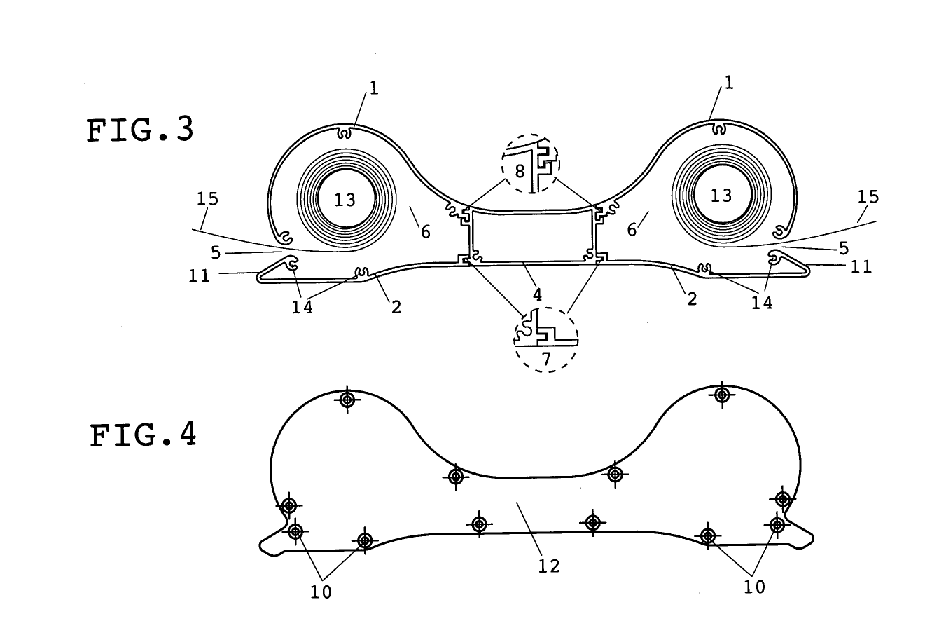

As shown in FIG. 3, two top arcuate profile 1 and two bottom flat profile 2 form two elongated housing 6 having two openings 5 respectively; a connecting body profile 4 connects to both top arcuate profile 1 with an interlocking method 8; said connecting body profile 4 connects to both bottom flat profile 2 with a non-interlocking method 7. This forms the profile configuration for a double-sided retractable banner display device.

FIG. 4 shows a side plate 12 for a double-sided display device; screw positions for fastening the profile configuration for a double-sided retractable display device as shown in FIG. 3.

As shown in FIG. 4, two screw positions 10 match to two screw threads 14 on a bottom flat profile 2 as shown in FIG. 3. As a result of the non-interlocking connecting method 7 as shown in FIG. 3, once all screws fasten two side plates 12 to both end of the profile configuration for a double-sided retractable display device as shown in FIG. 3, the bottom flat profile 2 can be removed and replaced by unscrewing two screws in screw positions 10; and the structure of the display device sustains.

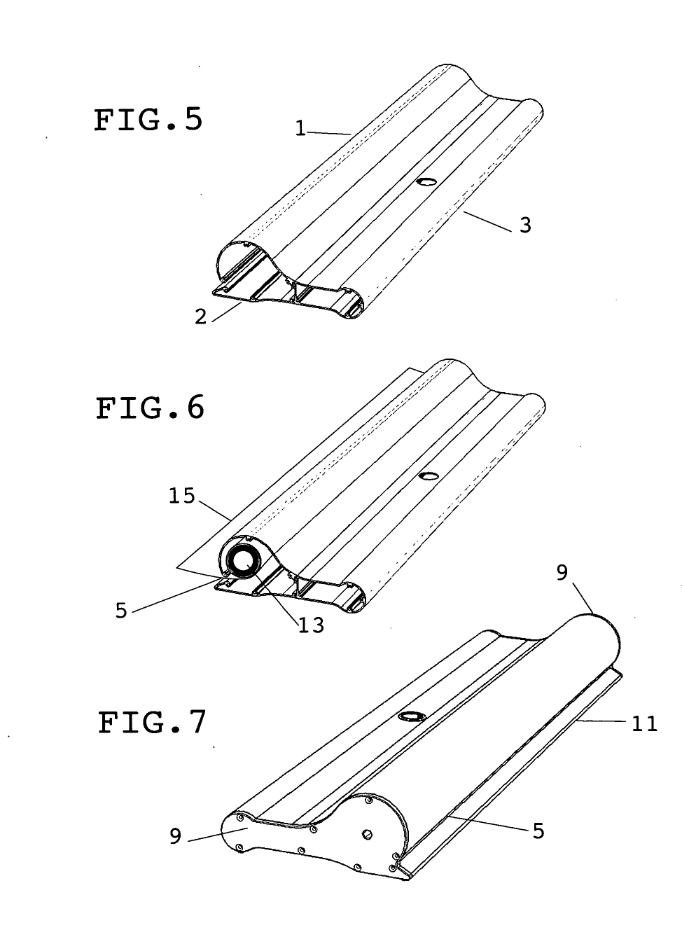

As shown in FIG. 5, a top arcuate profile 1, a bottom flat profile 2 and a connecting body profile 3 form an elongated profile configuration for a single side retractable banner display device.

FIG. 6 shows the profile configuration for a single side retractable banner display device with an elongated housing that accommodates an example of drum structure 13 extending longitudinally between two opposed side plates 9 as shown in FIG. 7. Banner 15 can be wound around said drum; a function of said drum structure is retracting and extending banner through opening 5;

FIG. 7 shows a perspective view of the profile configuration for a single side retractable banner display device with two opposed side plates 9 fasten an elongated structures at both ends of said display device; Banner can be extended and retracted through opening 5; a tapered front edge 11 extends forward over an opening 5 is a portion of a bottom flat profile 2 as shown in FIG. 1.

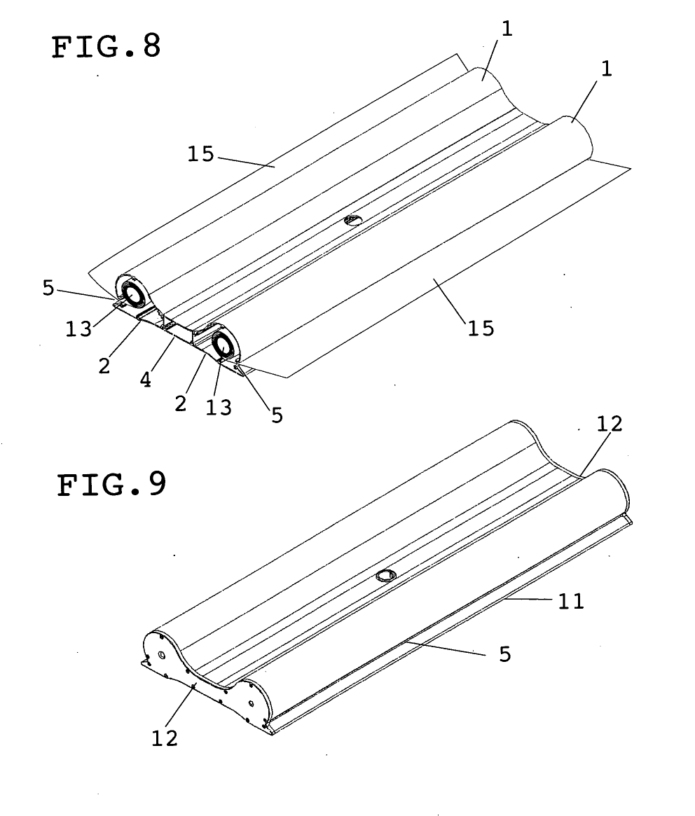

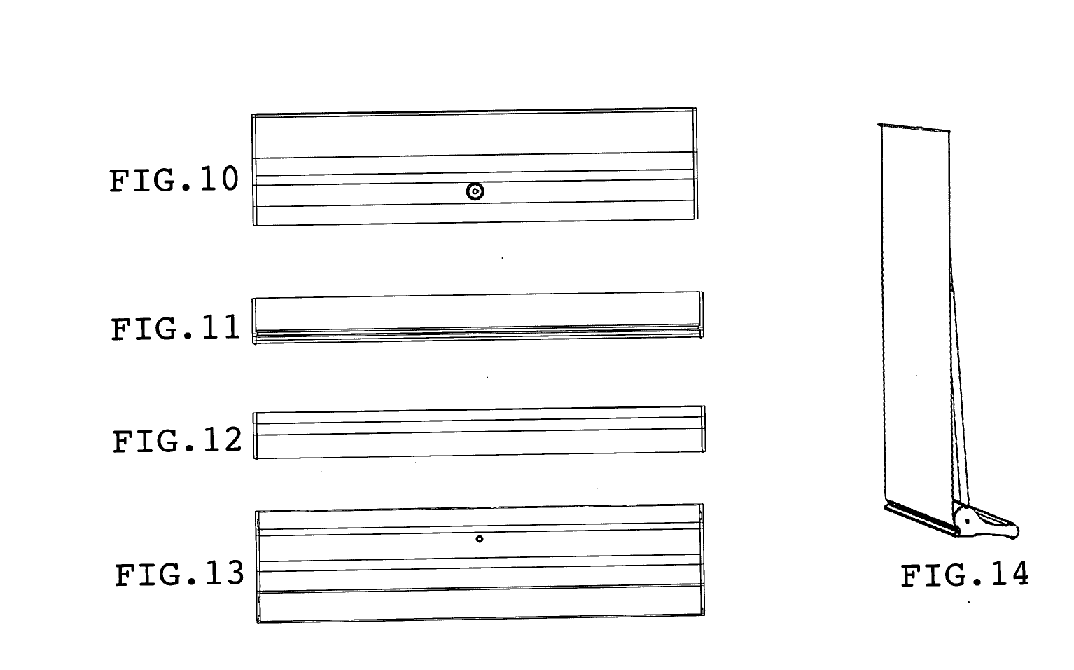

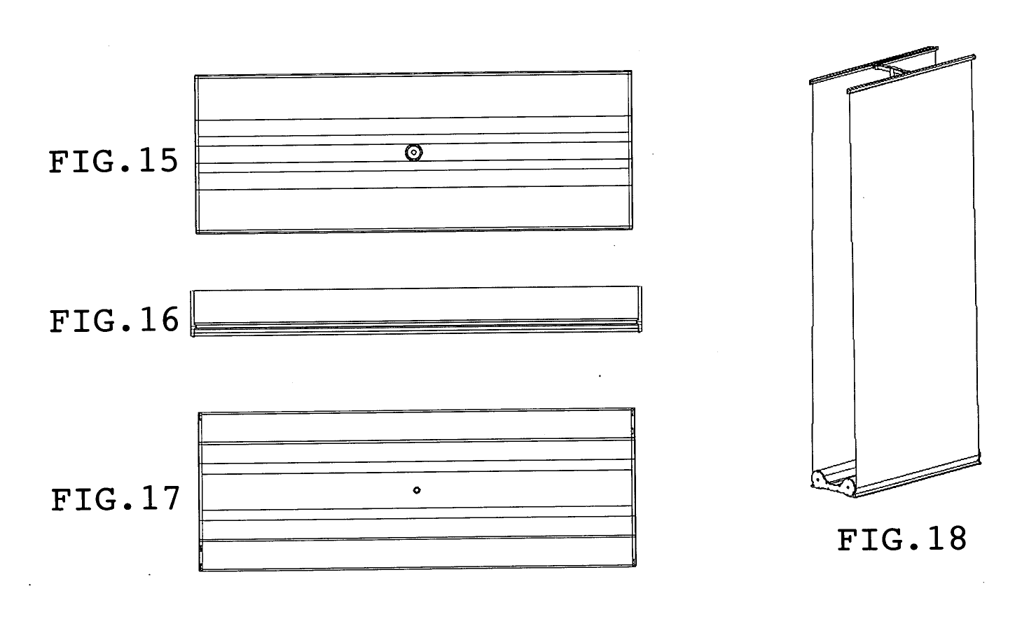

FIG. 8 shows the profile configuration for a double-sided retractable banner display device with an elongated housing that accommodates two example of drum structures 13 extending longitudinally between two opposed side plates 12 as shown in FIG. 9. Banners 15 can be wound around said drums; a function of said drum structures is retracting and extending banner through opening 5;

FIG. 9 shows a perspective view of the profile configuration for a double-sided retractable banner display device with two opposed side plates 12 fasten an elongated structure at both ends of said display device; Banners can be extended and retracted through openings 5; a tapered front edge 11 extends forward over an opening 5 is a portion of a bottom flat profile 2 as shown in FIG. 3.

The present invention claimed is:

1. A series of profile configurations for retractable banner display devices comprising: at least one top arcuate profile, one bottom flat profile and one connecting body profile; said top arcuate profile and said bottom flat profile form an elongated housing having the opening located substantially low towards a ground surface; at least one connecting body profile integrates with the top arcuate profile(s) and the bottom flat profile(s) forming elongated structures of said display devices; two opposed side plates fasten at both ends of said display devices.

2. A series of profile configurations for retractable banner display devices comprising: at least one top arcuate profile, one bottom flat profile and one connecting body profile; wherein said top arcuate profile and said bottom flat profile form an elongated housing accommodates at least one type of drum structure extending longitudinally between said side plates;

3. A series of profile configurations for retractable banner display devices comprising: at least one top arcuate profile, one bottom flat profile and one connecting body profile; at least one connecting body profile integrates with the top arcuate profile(s) and the bottom flat profile(s) forming elongated structures of said display devices; two opposed side plates fasten at both ends of said display devices; wherein said top arcuate profile and said bottom flat profile form an elongated housing having the opening extending longitudinally between said two opposed side plates. The said opening is located substantially low towards a ground surface. Banner can be extended and retracted through the said opening.

4. A series of profile configurations for retractable banner display devices comprising: at least one top arcuate profile, one bottom flat profile and one connecting body profile; wherein said bottom flat profile with a tapered front edge extends forward over the said opening.

5. A series of profile configurations for retractable banner display devices comprising: at least one top arcuate profile, one bottom flat profile and one connecting body profile; wherein said bottom flat profile and said connection body profile are connected in a form of non-interlocking connection.

6. A series of profile configurations for retractable banner display devices comprising: at least one top arcuate profile, one bottom flat profile and one connecting body profile; wherein said connecting body profile integrates with said top arcuate profile(s) and said bottom flat profile(s) forming structures of said display devices for a single or a double-sided banner display.

7. (canceled)
